(19) United States
(12) Patent Application Publication
(10) Pub. No.: US 2019/0349765 A1
(43) Pub. Date: Nov. 14, 2019

(54) FAKE GNB/ENB DETECTION USING IDENTITY-BASED AUTHENTICATION AND ENCRYPTION

(71) Applicant: Intel IP Corporation, Santa Clara, CA (US)

(72) Inventors: Abhijeet KOLEKAR, Hillsboro, OR (US); Farid ADRANGI, Lake Oswego, OR (US); Robert ZAUS, Munchen (DE); Sudeep M. VAMANAN, Nuremberg (DE)

(73) Assignee: Intel IP Corporation, Santa Clara, CA (US)

(21) Appl. No.: 16/479,895

(22) PCT Filed: Jan. 4, 2018
(86) PCT No.: PCT/US2018/012385

§ 371 Date: Jul. 22, 2019

Related U.S. Application Data
(60) Provisional application No. 62/452,245, filed on Jan. 30, 2017.

(51) Int. Cl. H04W 12/06; H04L 9/08; H04L 9/32; H04W 12/04; H04W 12/10; H04W 12/12

(52) U.S. Cl. CPC H04W 12/06; H04L 9/0847; H04L 9/3252; H04L 2209/80; H04W 12/10; H04W 12/12; H04W 12/0401

(57) ABSTRACT

Embodiments are generally directed to fake gNB/eNB detection using identity-based authentication and encryption. An embodiment of an apparatus of a user equipment (UE) to perform an identity-based authentication and encryption process includes one or more baseband processors to generate a Radio Resource Control (RRC) Verify-Request message to an Evolved Node B (eNB) or Next Generation Node B (gNB) in response to receiving an RRCConnectionRelease message in a Cell Reselection process, the UE being in RRC idle mode, process an RRC Verify-Response message received from the eNB in response to the RRC Verify-Request message, and verify authenticity of the eNB or gNB by verifying the RRC Verify-Response message; and a memory to store the messages for the identity-based authentication and encryption process.

### RELATED APPLICATION

This application claims the benefit under 35 USC 119(e) of U.S. Provisional Patent Application No. 62/452,245 filed Jan. 30, 2017, which application is incorporated herein by reference as if fully set forth.

### TECHNICAL FIELD

Embodiments described herein generally relate to the field of communications and, more particularly, fake gNB/eNB detection using identity-based authentication and encryption.

### BACKGROUND

An idle User Equipment (UE) in a 3GPP Long-Term Evolution (LTE) or 5G New Radio (NR) network is not attached to any base station (an Evolved Node B (eNB) or Next Generation Node B (gNB)). However, the idle UE (the UE being in Radio Resource Control (RRC) idle mode) is required to select a suitable cell and camp on such cell. The process by which an idle UE selects and camps on a cell is referred to as Cell Selection. The UE uses Cell Selection for fast cell searching to camp on, wherein camping on the cell refers to the process for the UE to receiving system information by tuning to the control channels.

The UE will then register its presence in the registration area of the chosen cell by the Non-Access Stratum (NAS) registration procedure. The NAS registration procedure includes the LTE upper layer information being transmitted from UE to the Core Network (CN) via Access Stratum (AS). A cell may be selected if it is found to be suitable in fulfilling the cell selection criteria.

An idle UE that is camping on a cell will monitor other cells, and may make a determination to camp on another cell if the radio conditions change, such as when the UE moves between cells or other events, in the Cell Reselection process.

However, during Cell Reselection it is possible for a fake base station (eNB/gNB) to be present and to communicate with the UE. If the UE camps on such a fake cell during the RRC Idle State, when no authenticity verification is performed, then the attacker can in some circumstances successfully mount a Denial of Service (DoS) attack on the UE.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of fake gNB/eNB detection according to some embodiments;

FIG. 2 is an illustration of a bidding down attack between a UE and a base station;

FIG. 3 is an illustration of a process for eNB verification using identity-based authentication following redirection according to some embodiments;

FIG. 4A illustrates an RRC Verify-Request message in identity-based authentication according to some embodiments;

FIG. 4B illustrates an RRC Verify-Response message in identity-based authentication according to some embodiments;

FIG. 5 is a flowchart to illustrate a process for eNB verification in Cell Reselection according to some embodiments;

FIG. 6 is an illustration of a system for detection of a fake base station according to some embodiments;

FIG. 7 illustrates an architecture of a system of a network in accordance with some embodiments;

FIG. 8 illustrates example components of a device in accordance with some embodiments;

FIG. 9 illustrates example interfaces of baseband circuitry in accordance with some embodiments; and

FIG. 10 is a block diagram illustrating components, according to some example embodiments, able to read instructions from a machine-readable or computer-readable medium and perform one or more methodologies.

### DETAILED DESCRIPTION

Embodiments described herein are generally directed to fake gNB/eNB detection using identity-based authentication and encryption.

3GPP TR 33.899 (3rd Generation Partnership Project; Technical Specification Group Services and System Aspects; Study on the security aspects of the next generation system (Release 14)) describes a key issue for AS security during RRC idle mode, the key issue being the provision of assistance to a UE during the Cell Reselection process to detect fake 5G gNB/eNB and associate with a genuine cell by verifying the authenticity of the cell.

In the LTE system, a UE obtains certain services in the RRC idle state. In the RRC idle state, UE acquires the system information from the camped cell and uses them to receive paging and obtain other services such as MBMS, D2D, etc. in RRC idle state. However, when the UE selects a cell in RRC idle mode, the UE does not validate whether the eNB is authentic or fake. As a result, UE may potentially camp to a rogue cell leading to denial of services (such as public safety warnings, incoming emergency calls, real-time application server push services, proximity services, etc.) in a DoS attack on the UE. An example of a RRC idle mode bidding down attack may occur when a UE camps with a fake gNB and the UE is redirected to another GSM network, the network being a 2G network with lower security.

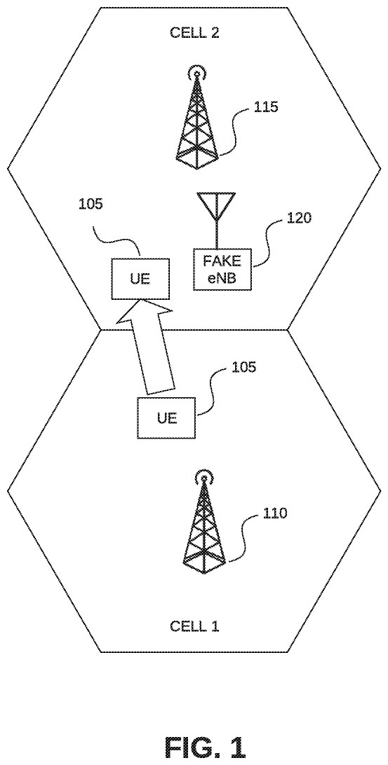

FIG. 1 is an illustration of fake gNB/eNB detection according to some embodiments. As shown in FIG. 1, a UE 105 in RRC idle state is moved from a first location to a second location. In this example, the UE 105 had initially camped on a first base station 110 (eNB/gNB), shown in the simple network structure as serving a first cell (shown as Cell 1). Upon moving from the first location to the second location, the UE may conduct the Cell Reselection process. As shown in FIG. 1, a second base station 115 is serving a second cell (Cell 2).

However, a fake base station 120 is present nearby the UE 105. As no authenticity verification is performed in the RRC Idle state, the fake base station can communicate with the UE in a bidding down attack, and attempt to switch the UE 105 to a G2 network, which network is much more vulnerable to attack than the 5G network.

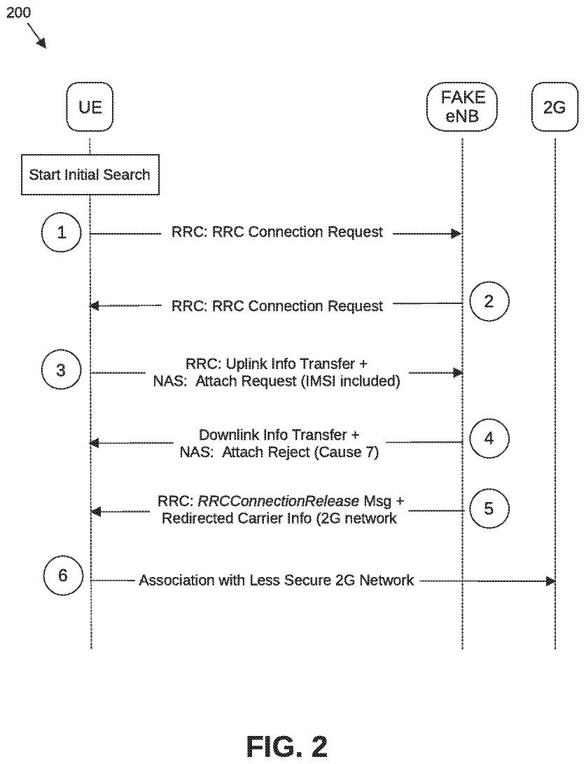

A fake 5G eNB/gNB can deny LTE/5G services to an LTE/5G device, thereby effectively downgrading the device to 2G. Once downgraded, the device is open to all legacy 2G vulnerabilities. The parameter negotiation during the LTE attach process is vulnerable to bidding down attacks by a fake eNB/gNB that can fool an LTE device into believing that the device can only communicate using 2G. As shown in FIG. 2, a UE 105 may receive an unprotected RRCConnectionRelease message from a fake 5G eNB/gNB with redirection to another GSM network, the network being a 2G network with lower security. (3GPP TS 36.331 3rd Generation Partnership Project; Technical Specification Group Radio Access Network; Evolved Universal Terrestrial Radio Access (E-UTRA); Radio Resource Control (RRC); Protocol specification (Release 14), section 5.3.8—RRC Connection Release)

In some embodiments, the UE 105 provides for detection of a fake gNB/eNB using identify based authentication and encryption, which detection thus may be applied to prevent a bidding down attack on the UE 105.

FIG. 2 is an illustration of a bidding down attack between a UE and a base station. As illustrated in FIG. 2, the bidding down attack in a communication between a UE (the UE being in an RRC idle state) and a fake eNB may include the following in which the UE commences an initial search for a cell to camp on:

(1) UE-RRC: Presents RRC connection request, which in this circumstance is received by a fake eNB.

(2) Fake eNB-RRC: Returns RRC connection setup to the UE.

(3) UE-RRC: Uplink information transfer; plus Non-Access Stratum (NAS): Attach Request (International Mobile Subscriber Identity (IMSI) included).

(4) Fake eNB—Downlink information transfer; plus NAS: Attach Reject (Cause 7). When a request cannot be accepted by the network, then an Attach Reject message is provided to the UE, with Cause 7 indicating Evolved Packer Service (EPS) service not allowed. In this manner, the fake eNB is attempting to indicate to the UE that higher level communications are not available.

(5) Fake eNB-RRC: RRCConnectionRelease message; plus redirected carrier information (for 2G network).

(6) UE—Association with less secure 2G network, thus endangering the UE to denial of services.

3GPP TR 33.899 provides certain possible solutions for enabling a UE to provide for verification of authenticity of the cell during RRC idle mode and fake gNB detection. However, the solutions have certain disadvantages, and are not capable of protecting against all replay attacks and denial of service attacks. The suggested solutions include:

(1) 5.4.4.4.2—Fake gNB Detection Using UL Traffic Monitoring:

The first solution provides:

In this method, the UE in Idle mode, when other conditions for Cell reselection and camping are met UE scans and monitor whether the cell has live UL link traffic.

In this first solution, success of fake gNB detection is dependent on whether there is UL traffic to a new redirected eNB (i.e., the fake eNB).

However, this method is not fully secure as it may be possible for a fake eNB/gNB to pump fake data in in uplink, and thus to make it appear that the cell has live UL link traffic.

Another limitation to the solution is that a genuine cell may not always be serving UEs on the Uplink. There may not be UEs transmitting all the time in every frame, particularly at late night or early morning hours. For this reason, examination of UL link traffic may not always be a useful test.

(2) 5.4.4.2.2.1—System Information Verification Using Digital Signatures

The second solution states that:

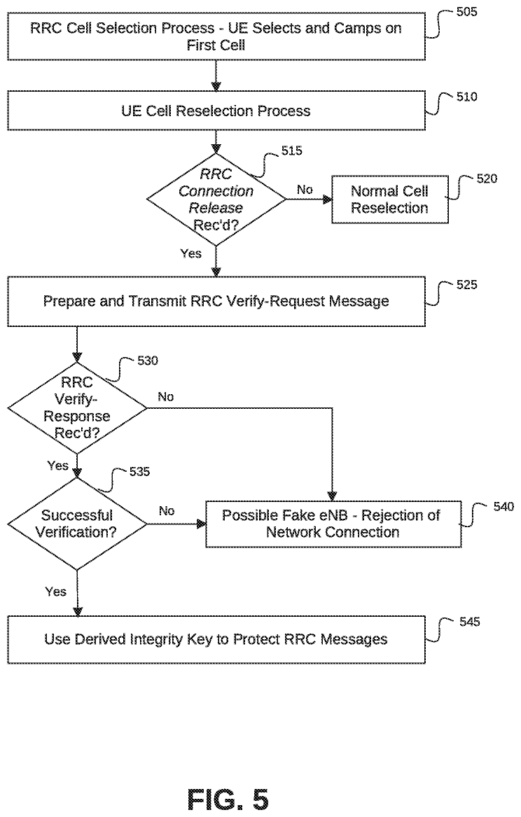

In order to enable the UE to validate the authenticity of received system information, the NR digitally signs the broadcasted system information as shown in Figure 5.4.4.2.2.1-1. System information to be broadcasted, Private security key (K-SIG_{Private}) and Time Counter are input to security algorithm to generate the digital signature. The generated DS together with some least significant bits of Time Counter is added to the system information before transmitting over the air. KSIG_{Private} is specific to the Tracking area. The private key (K—InPᵣᵢᵥₐₜₑ) provisioned in the NR by the MNO. The public K-SIG_{public} key is provisioned by the core network to the UE, when performing location update procedure. Time Counter is maintained based on UTC time and can be units of seconds or minutes. The Time Counter input to the security algorithm is the value of counter corresponding to time slot in which system information is transmitted. The usage of Time Counter ensures that received system information cannot be replayed. There can be differences in the Time Counter maintained in the UE and the AN because of different UTC source or implementation errors. To take care of these errors least significant bits of Time Counter are also transmitted along with system information.”

The second solution has the following disadvantages:

(a) Not all SIBs need to be digitally signed. A UE is able to operate without a Universal Subscriber Identity Module (USIM) (for emergency calls) and on a Public Land Mobile Network (PLMN) not in the Operator's controlled lists in the USIM. In such cases, the UE cannot be expected to know the public key of all PLMNs it would operate on.

(b). UTC time is in 24 Hours format. If an attacker obtains a log of the broadcasted MIB and SIBs with time stamp, digital signature, SFN, etc., for 24 hours from a valid cell, with all the parameters, the attacker is in possession of the system information matching time stamp and digital signature. The attacker thus could masquerade as the original cell, its cell ID, frequency parameter, etc., and broadcast the same MIB/SIB information by playing the log file.

In some embodiments, an apparatus, system, or process provides an Identity Based Signature (IBS) based solution for gNB/eNB detection, which may be utilized in prevention of a potential bidding down attach on a UE. In some embodiments, an IBS-based mutual validation/verification process between the UE and the eNB/gNB is to connect during Cell Reselection or Cell Redirection, which may be utilized to detect the presence of a fake gNB/eNB in such processes.

In some embodiments, an apparatus, system, or process includes the following:

(1) A UE, when a cell redirection message is received, is to send a short RRC Verify-Request message to the new/intended eNB (or the Common Control Function (CCNF) where the NAS context of the UE is held). The UE includes a freshness parameter UE-NONCE (a nonce in general being a value, such as random or pseudo-random number, that is issued in an authentication protocol and that can only be used once) and UE Identity in the RRC Verify-Request message. In some embodiments, a Secret Signing Key as defined in RFC 6507 is used to SIGN the RRC Verify-Request Message. (RFC 6507: Elliptic Curve-Based Certificateless Signatures for Identity-Based Encryption (ECCSI), Internet Engineering Task Force (IETF), February 2012.)

(2) A Response to the RRC Verify-Request, referred to as the RRC Verify-Response message, is to be generated by the serving system network element (eNB or CCNF). The private key of the eNB is utilized to digitally sign the RRC Verify-Response message. The RRC Verify-Response is to include (UE-Nonce|eNB-Nonce|E-UTRAN Cell Global Identifier (ECGI)|Key Management Service Identification (KMS-ID)) and other parameters, for example SAKKE (Sakai-Kasahara Key Encryption) payload, enabling the UE to derive a shared secret value (SSV) as defined in RFC 6508. UE verifies the signed response using Public Validation Token (PVT). (RFC 6508: Sakai-Kasahara Key Encryption (SAKKE), Internet Engineering Task Force (IETF), February 2012.)

(3) Upon successful verification, the UE then derives the SAKKE SSV from the RRC Verify Response message. This shared secret value is to be used to generate the Short Message Authentication Code for Integrity (ShortMAC-I), which may be used to secure all of RRC messages until UE authentication (i.e. until AS Security Context is established at Evolved Packet Core (EPC) and UE) is performed with the eNB. After successful Verification, the UE can continue establishing the Radio Signal bearers or continue with RRC procedures.

In the embodiments described herein, the following pre-conditions may be applicable:

(1) The UEs and eNB/gNBs are provisioned with the required credentials (as defined in RFC 6507 and RFC 6508) in advance when the UEs have secure access to their Key Management Server (KMS).

(2) The KMS, the common root of trust for the UEs and eNB/gNB, provisions the UEs with a set of credentials for Elliptic Curve-Based Certificateless Signatures for ID-based encryption ECCSI and SAKKE schemes.

(3) Upon successful provisioning for ECCSI, each UE and eNB will be configured with the public key of the KMS, and a set of credentials associated with the UE's identity, the set of credentials being: Secret Signing Key (SSK) and Public Validation Token (PVT). The UE is to act as both “signer” and “verifier”. As a signer, the UE uses its SSK to sign a message, and when acting as a verifier, the UE uses the public key of the KMS and the signer's PVT to verify the signature.

(4) Upon successful provisioning for SAKKE, each UE will be configured with the public key of the KMS, and a Receiver Secret Key (RSK) that is associated with the UE's identity. The sender UE is to use the eNB/gNB identity (receiving entity for SAKKE payload) and the public key of the KMS to create an encrypted SAKKE payload. The eNB/gNB is to uses its identity, its Receiver Secret Key and the public key of the KMS to decrypt the SAKKE payload.

(5) The public identity of a UE may be encoded in any format that is compatible with the guidelines provided in RFC 6509. For example, the public identity of a UE may be a concatenation of a fixed part (in the form of IMSI, Session Initiation Protocol (SIP) Uniform Resource Identifier (URI), Telephone (TEL) URI, other user@domain types of URI, etc.) and a varying part (in the form of a timestamp). RFC 6509 provides certain examples, such as IMSI:expiration-date@domain.com.

(6) The eNB is be configured with the public key of the KMS and ECGI that is used as IBS identity (=eNB public key).

(7) To avoid signaling overhead concern, the performance of the Verify-Request, Verify-Accept process may not be required at all times. One optimization may include sending the RRC Verify-Request message only during the RRCConnectionRelease message when Cell-Redirection is received by UE.

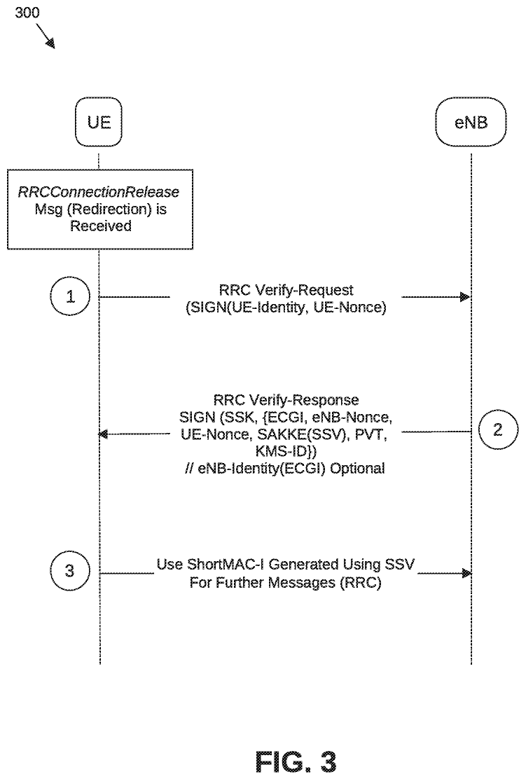

FIG. 3 is an illustration of a process for eNB verification using identity-based authentication following redirection according to some embodiments. In some embodiments, upon an RRCConnectionRelease message (a redirection) being received by a UE, a process for eNB verification includes the following:

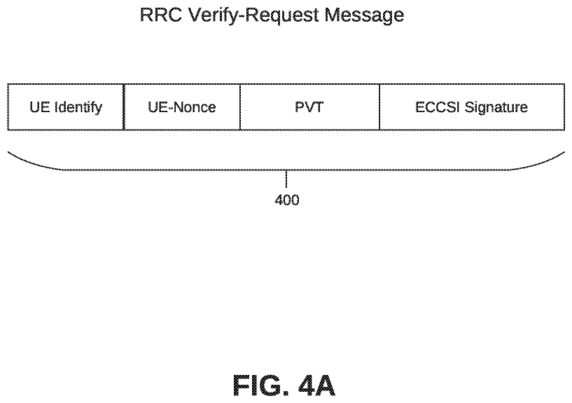

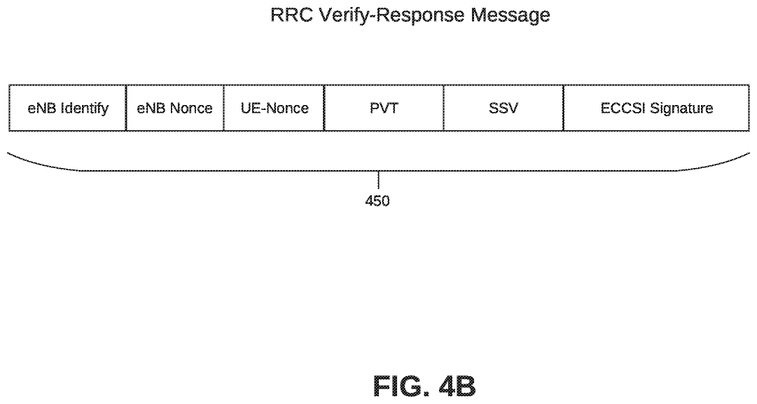

(1) The UE sends an RRC Verify-Request message to the eNB (or the Common Control Function (CCNF) where the NAS context of the UE is held). In some embodiments, the RRC Verify-Request message (as illustrated in FIG. 4A as RRC Verify-Request message 400 for identity-based authentication) includes the following parameters:

(a) UE Identity;

(b) UE Nonce;

(c) Public Verification Token (PVT); and

(d) SIGN—An ECCSI signature is computed over the UE Identity and UE-Nonce.

(2) In response to the RRC Verify-Request message, the Serving System network element (eNB or CCNF) is to generate an RRC Verify-Response message. The eNB verifies the signature payload SIGN in the RRC Verify-Request message. If the verification test is successful, eNB sends the RRC Verify-Response message (as illustrated in FIG. 4B as RRC Verify-Response message 450 for identity-based authentication) including the following parameters:

(a) eNB Identity—This information may be used to derive the Signer's identifier (used by ECCSI). The eNB identity is optional.

(b) eNB Nonce;

(c) UE Nonce;

(d) PVT (Public Verification Token);

(e) SSV (Shared Secret Value) generated by eNB and encrypted using SAKKE; and

(f) SIGN—an ECCSI signature of the RRC Verify-Response message. The signature is computed over the User of eNB Identity (if included), Nonce-UE, Nonce-eNB and the SAKKE parameters (Shared Secret Value, as follows).

Upon receipt of the RRC Verify-Response message, the UE verifies the signature payload SIGN. If the verification test is successful, the UE decrypts the SAKKE payload to extract the SSV, which is used as a security association key between the UE and eNB. The UE and eNB use this key to derive an integrity key for integrity protecting RRC messages.

(3) Upon successful verification, the UE may use the derived integrity key to protect RRC messages until the UE authenticates with eNB. (i.e. until AS Security context is established at EPC and UE).

FIG. 5 is a flowchart to illustrate a process for eNB verification in Cell Reselection according to some embodiments. In some embodiments, a process may include:

505: A UE in an RRC idle state performs a Cell Selection process in which the UE selects and camps on a first cell.

510: The UE in the RRC idle state performs Cell Reselection with an eNB, such as upon radio conditions changing.

515: A determination may be made whether an RRCConnectionRelease message (redirection) is received in response to the Cell Reselection.

520: If not, a normal Cell Reselection may proceed.

525: If an RRCConnectionRelease message is received, then the UE is to prepare and transmit an RRC Verify-Request message, as illustrated in FIGS. 3 and 4A,

530: A determination is made whether an RRC Verify-Response message, as illustrated in FIGS. 3 and 4B, is received by the UE in response to the RRC Verify-Request message.

535: If so, there is determination whether there is successful verification of the RRC Verify-Response message.

540: If no RRC Verify-Response message is received or if the message cannot be verified, then there is a possible detection of a fake eNB, and a rejection of the network connection. In some embodiments, the UE may again proceed with Cell Reselection

545: If there is successful verification of the RRC Verify-Response message, then the UE may use the derived integrity key to protect RRC messages until the UE authenticates with the eNB.

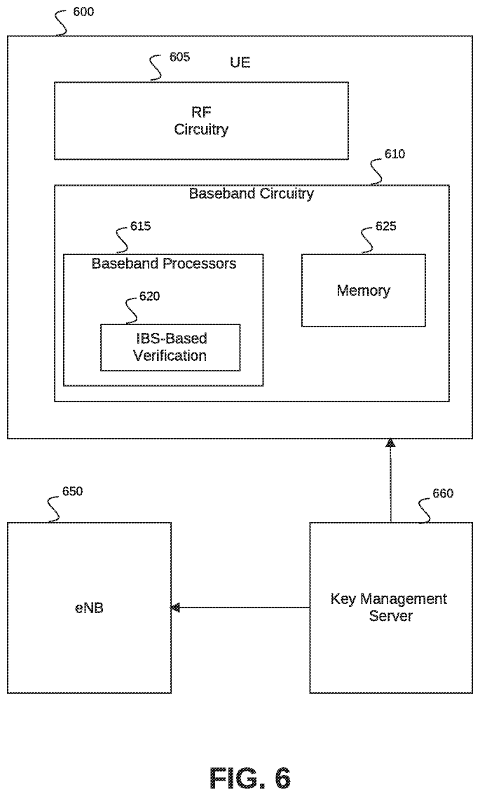

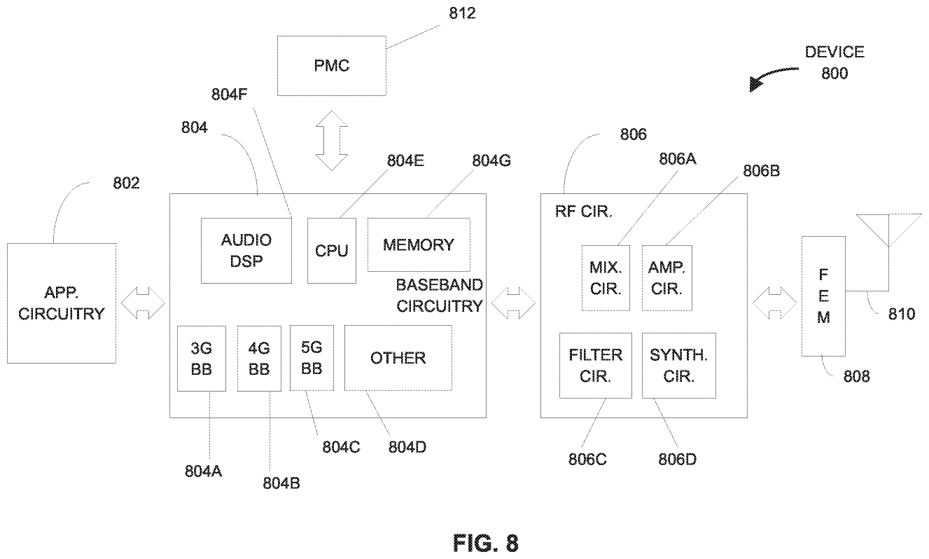

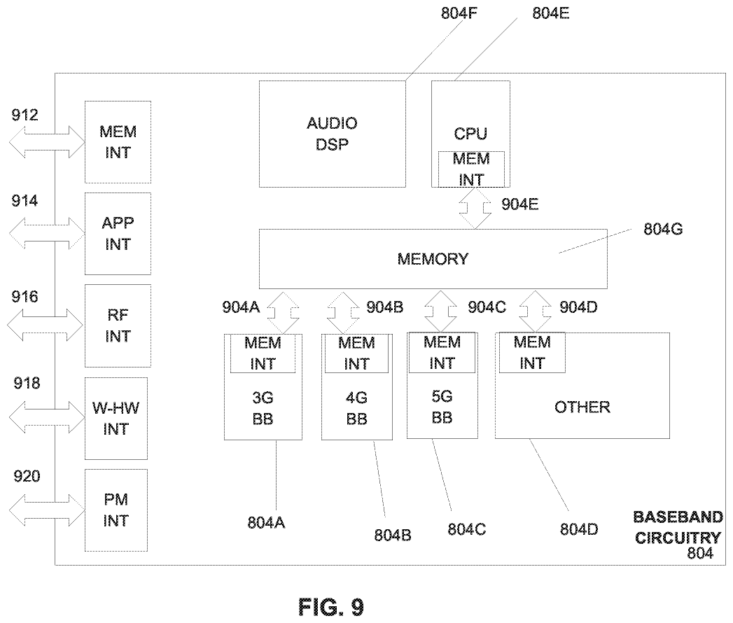

FIG. 6 is an illustration of a system for detection of a fake base station according to some embodiments. In some embodiments, a UE 600 (such as UE 800 illustrated in FIG. 8) includes RF circuitry 605 and baseband circuitry 610 including one or more baseband processors 615, such as the baseband circuitry 804 including baseband processors 804A-804C illustrated in FIGS. 8 and 9. In some embodiments, the baseband circuitry includes memory 625. In some embodiments, the one or more baseband processors 615 include IBS-based verification of eNBs 650, such as the verification processes illustrated in FIGS. 3 and 5.

In some embodiments, the IBS-based verification may include the use by the UE and eNB with a public key of a key management server 660. In some embodiments, the UE is to receive set of credentials associated with the UE's identity (the set of credentials being a Secret Signing Key (SSK) and Public Validation Token (PVT)) for use in the IBS-based verification process.

In some embodiments, a mechanism is provided by which a NextGen UE can detect a fake eNB/gNB.

In some embodiments, a mechanism is provided by which a NextGen UE performs mutual verification with next generation eNB or gNB.

In some embodiments, a mechanism is provided by which a NextGen UE is redirected to a new eNB/gNB after an RRCConnectionRelease message with redirection is received.

In some embodiments, a mechanism is provided by which a UE can securely verify the integrity of the eNB/gNB and whether or not it is a certified and compliant NextGen eNB/gNB.

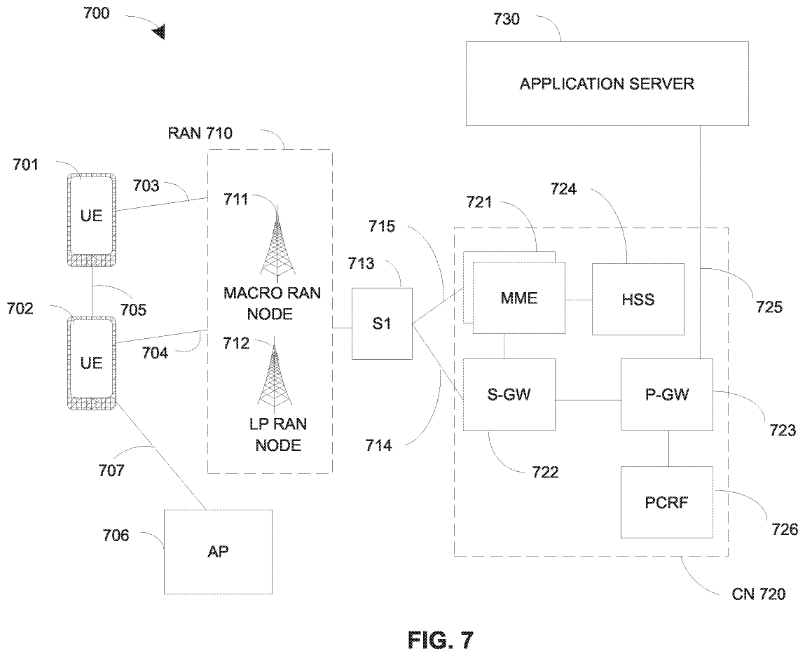

FIG. 7 illustrates an architecture of a system 700 of a network in accordance with some embodiments. The system 700 is shown to include a user equipment (UE) 701 and a UE 702. The UEs 701 and 702 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 701 and 702 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 701 and 702 may be configured to connect, e.g., communicatively couple, with a radio access network (RAN) 710—the RAN 710 may be, for example, an Evolved Universal Mobile Telecommunications System (UMTS) Terrestrial Radio Access Network (E-UTRAN), a NextGen RAN (NG RAN), or some other type of RAN. The UEs 701 and 702 utilize connections 703 and 704, respectively, each of which comprises a physical communications interface or layer (discussed in further detail below); in this example, the connections 703 and 704 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 701 and 702 may further directly exchange communication data via a ProSe interface 705. The ProSe interface 705 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 702 is shown to be configured to access an access point (AP) 706 via connection 707. The connection 707 can comprise a local wireless connection, such as a connection consistent with any IEEE 802.11 protocol, wherein the AP 706 would comprise a wireless fidelity (WiFi®) router. In this example, the AP 706 is shown to be connected to the Internet without connecting to the core network of the wireless system (described in further detail below).

The RAN 710 can include one or more access nodes that enable the connections 703 and 704. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 710 may include one or more RAN nodes for providing macrocells, e.g., macro RAN node 711, and one or more RAN nodes for providing femtocells or picocells (e.g., cells having smaller coverage areas, smaller user capacity, or higher bandwidth compared to macrocells), e.g., low power (LP) RAN node 712.

Any of the RAN nodes 711 and 712 can terminate the air interface protocol and can be the first point of contact for the UEs 701 and 702. In some embodiments, any of the RAN nodes 711 and 712 can fulfill various logical functions for the RAN 710 including, but not limited to, radio network controller (RNC) functions such as radio bearer management, uplink and downlink dynamic radio resource management and data packet scheduling, and mobility management.

In accordance with some embodiments, the UEs 701 and 702 can be configured to communicate using Orthogonal Frequency-Division Multiplexing (01-DM) communication signals with each other or with any of the RAN nodes 711 and 712 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 711 and 712 to the UEs 701 and 702, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 701 and 702. The physical downlink control channel (PDCCH) may carry information about the transport format and resource allocations related to the PDSCH channel, among other things. It may also inform the UEs 701 and 702 about the transport format, resource allocation, and H-ARQ (Hybrid Automatic Repeat Request) information related to the uplink shared channel Typically, downlink scheduling (assigning control and shared channel resource blocks to the UE 102 within a cell) may be performed at any of the RAN nodes 711 and 712 based on channel quality information fed back from any of the UEs 701 and 702. The downlink resource assignment information may be sent on the PDCCH used for (e.g., assigned to) each of the UEs 701 and 702.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 710 is shown to be communicatively coupled to a core network (CN) 720—via an S1 interface 713. In embodiments, the CN 720 may be an evolved packet core (EPC) network, a NextGen Packet Core (NPC) network, or some other type of CN. In this embodiment the S1 interface 713 is split into two parts: the S1-U interface 714, which carries traffic data between the RAN nodes 711 and 712 and the serving gateway (S-GW) 722, and the S1-mobility management entity (MME) interface 715, which is a signaling interface between the RAN nodes 711 and 712 and MMEs 721.

In this embodiment, the CN 720 comprises the MMEs 721, the S-GW 722, the Packet Data Network (PDN) Gateway (P-GW) 723, and a home subscriber server (HSS) 724. The MMEs 721 may be similar in function to the control plane of legacy Serving General Packet Radio Service (GPRS) Support Nodes (SGSN). The MMEs 721 may manage mobility aspects in access such as gateway selection and tracking area list management. The HSS 724 may comprise a database for network users, including subscription-related information to support the network entities' handling of communication sessions. The CN 720 may comprise one or several HSSs 724, depending on the number of mobile subscribers, on the capacity of the equipment, on the organization of the network, etc. For example, the HSS 724 can provide support for routing/roaming, authentication, authorization, naming/addressing resolution, location dependencies, etc.

The S-GW 722 may terminate the S1 interface 713 towards the RAN 710, and routes data packets between the RAN 710 and the CN 720. In addition, the S-GW 722 may be a local mobility anchor point for inter-RAN node handovers and also may provide an anchor for inter-3GPP mobility. Other responsibilities may include lawful intercept, charging, and some policy enforcement.

The P-GW 723 may terminate an SGi interface toward a PDN. The P-GW 723 may route data packets between the EPC network 723 and external networks such as a network including the application server 730 (alternatively referred to as application function (AF)) via an Internet Protocol (IP) interface 725. Generally, the application server 730 may be an element offering applications that use IP bearer resources with the core network (e.g., UMTS Packet Services (PS) domain, LTE PS data services, etc.). In this embodiment, the P-GW 723 is shown to be communicatively coupled to an application server 730 via an IP communications interface 725. The application server 730 can also be configured to support one or more communication services (e.g., Voice-over-Internet Protocol (VoIP) sessions, PTT sessions, group communication sessions, social networking services, etc.) for the UEs 701 and 702 via the CN 720.

The P-GW 723 may further be a node for policy enforcement and charging data collection. Policy and Charging Enforcement Function (PCRF) 726 is the policy and charging control element of the CN 720. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 726 may be communicatively coupled to the application server 730 via the P-GW 723. The application server 730 may signal the PCRF 726 to indicate a new service flow and select the appropriate Quality of Service (QoS) and charging parameters. The PCRF 726 may provision this rule into a Policy and Charging Enforcement Function (PCEF) (not shown) with the appropriate traffic flow template (TFT) and QoS class of identifier (QCI), which commences the QoS and charging as specified by the application server 730.

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or a RAN node. In some embodiments, the device 800 may include less elements (e.g., a RAN node may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), preceding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

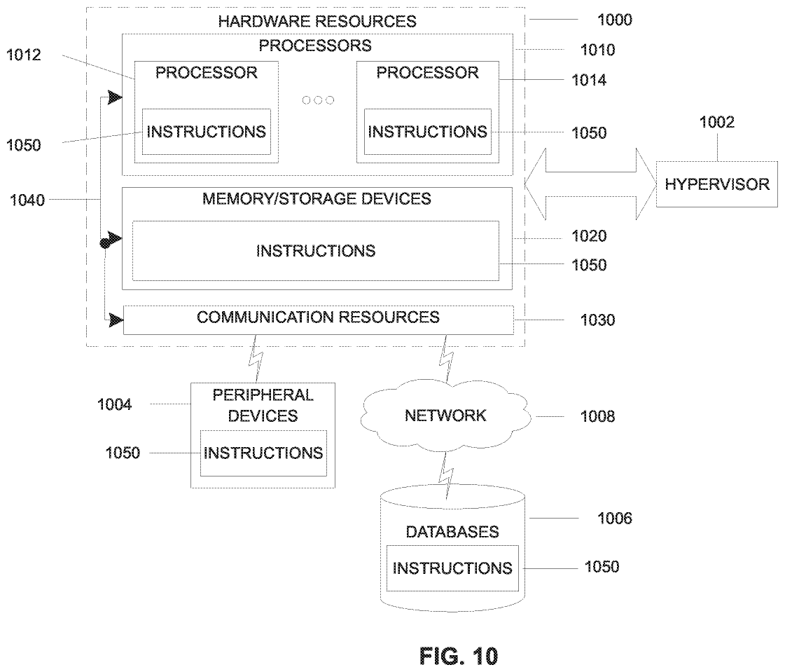

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

In some embodiments, an apparatus of a user equipment (UE) to perform an identity-based authentication and encryption process, the apparatus including one or more baseband processors to generate a Radio Resource Control (RRC) Verify-Request message to an Evolved Node B (eNB) or Next Generation Node B (gNB) in response to receiving an RRCConnectionRelease message in a Cell Reselection process, the UE being in RRC idle mode, process an RRC Verify-Response message received from the eNB or gNB in response to the RRC Verify-Request message, and verify authenticity of the eNB or gNB by verifying the RRC Verify-Response message; and a memory to store the messages for the identity-based authentication and encryption process.

In some embodiments, the RRCConnectionRelease message redirects the UE to a 2G network.

In some embodiments, the RRC Verify-Request message includes: a UE identity; a UE nonce; a Public Verification Token (PVT); and a signature computed over the UE identity and UE nonce.

In some embodiments, the signature is an Elliptic Curve-Based Certificateless Signatures for Identity-Based Encryption (ECCSI) signature.

In some embodiments, verifying the RRC Verify-Response message includes obtaining the following from the RRC Verify-Response message: an eNB/gNB nonce; the UE nonce; a PVT; a payload including a Secret Shared Value (SSV); and a signature computed over the eNB/gNB nonce, UE nonce, and payload.

In some embodiments, wherein the SSV is encrypted using Sakai-Kasahara Key Encryption (SAKKE).

In some embodiments, wherein verifying the RRC Verify-Response message further includes obtaining an eNB/gNB identity from the RRC Verify-Response message.

In some embodiments, the one or more baseband processors are further to: extract the SSV from the payload upon verifying the RRC Verify-Response message; and the derive an integrity key from the SSV.

In some embodiments, the one or more baseband processors are further to utilize the derived integrity key to protect RRC messages until the UE authenticates with the eNB/gNB.

In some embodiments, utilizing the derived integrity key includes generating a Short Message Authentication Code for Integrity (ShortMAC-I) for securing RRC messages.

In some embodiments, a computer-readable storage medium having stored thereon data representing sequences of instructions that, when executed by a processor, cause the processor to perform operations including camping a user equipment (UE) on a first cell in a Cell Selection process, the UE being in Radio Resource Control (RRC) idle mode; performing a Cell Reselection process by the UE in the RRC idle mode; receiving an RRCConnectionRelease message; transmitting an RRC Verify-Request message in response to the RRCConnectionRelease message; receiving an RRC Verify-Response message in response to the RRC Verify-Request message; and verifying authenticity of an Evolved Node B (eNB) or Next Generation Node B gNB by verifying the RRC Verify-Response message.

In some embodiments, the RRCConnectionRelease message redirects the UE to a 2G network.

In some embodiments, the RRC Verify-Request message includes: a UE identity; a UE nonce; a Public Verification Token (PVT); and a signature computed over the UE identity and UE nonce.

In some embodiments, verifying the RRC Verify-Response message includes obtaining the following from the RRC Verify-Response message: an eNB/gNB nonce; the UE nonce; a PVT; a payload including a Secret Shared Value (SSV); and a signature computed over the eNB/gNB nonce, UE nonce, and payload.

In some embodiments, verifying the RRC Verify-Response message further includes obtaining an eNB/gNB identity from the RRC Verify-Response message.

In some embodiments, the medium further includes instruction for: upon verifying the RRC Verify-Response message, extracting the SSV from the payload; and deriving an integrity key from the SSV.

In some embodiments, the medium further includes instruction for: utilizing the derived integrity key to protect RRC messages until the UE authenticates with the eNB/gNB.

In some embodiments, an apparatus includes means for camping a user equipment (UE) on a first cell in a Cell Selection process, the UE being in Radio Resource Control (RRC) idle mode; means for performing a Cell Reselection process by the UE in the RRC idle mode; means for receiving an RRCConnectionRelease message; transmitting an RRC Verify-Request message in response to the RRCConnectionRelease message; means for receiving an RRC Verify-Response message in response to the RRC Verify-Request message; and means for verifying authenticity of an Evolved Node B (eNB) or Next Generation Node B (gNB) by verifying the RRC Verify-Response message.

In some embodiments, the RRCConnectionRelease message redirects the UE to a 2G network.

In some embodiments, the RRC Verify-Request message includes: a UE identity; a UE nonce; a Public Verification Token (PVT); and a signature computed over the UE identity and UE nonce.

In some embodiments, verifying the RRC Verify-Response message includes obtaining the following from the RRC Verify-Response message: an eNB/gNB nonce; the UE nonce; a PVT; a payload including a Secret Shared Value (SSV); and a signature computed over the eNB/gNB nonce, UE nonce, and payload.

In some embodiments, verifying the RRC Verify-Response message further includes obtaining an eNB/gNB identity from the RRC Verify-Response message.

In some embodiments, the apparatus further includes means for extracting the SSV from the payload upon verifying the RRC Verify-Response message; and means for deriving an integrity key from the SSV.

In some embodiments, the apparatus further includes means for utilizing the derived integrity key to protect RRC messages until the UE authenticates with the eNB/gNB.

In some embodiments, a system of a user equipment (UE) to perform an identity-based authentication and encryption process includes: one or more baseband processors to generate a Radio Resource Control (RRC) Verify-Request message to an Evolved Node B (eNB) or Next Generation Node B (gNB) in response to receiving an RRCConnectionRelease message in a Cell Reselection process, the UE being in RRC idle mode, process an RRC Verify-Response message received from the eNB or gNB in response to the RRC Verify-Request message, and verify authenticity of the eNB or gNB by verifying the RRC Verify-Response message; a memory to store the messages for the identity-based authentication and encryption process; a transmitter or receiver to transmit or receive signals; and an antenna for wireless signal reception and transmission.

In some embodiments, wherein the RRCConnectionRelease message redirects the UE to a 2G network.

In some embodiments, the RRC Verify-Request message includes: a UE identity; a UE nonce; a Public Verification Token (PVT); and a signature computed over the UE identity and UE nonce.

In some embodiments, verifying the RRC Verify-Response message includes obtaining the following from the RRC Verify Response message: an eNB/gNB nonce; the UE nonce; a PVT; a payload including a Secret Shared Value (SSV); and a signature computed over the eNB/gNB nonce, UE nonce, and payload.

In some embodiments, verifying the RRC Verify-Response message further includes obtaining an eNB/gNB identity from the RRC Verify-Response message.

In some embodiments, the one or more baseband processors are further to extract the SSV from the payload upon verifying the RRC Verify-Response message; and derive an integrity key from the SSV.

In some embodiments, the one or more baseband processors are further to utilize the derived integrity key to protect RRC messages until the UE authenticates with the eNB/gNB.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer. In some embodiments, a non-transitory computer-readable storage medium has stored thereon data representing sequences of instructions that, when executed by a processor, cause the processor to perform certain operations.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. An apparatus of a user equipment (UE) to perform an identity-based authentication and encryption process, the apparatus comprising:
one or more baseband processors to:
generate a Radio Resource Control (RRC) Verify-Request message to an Evolved Node B (eNB) or Next Generation Node B (gNB) in response to receiving an RRCConnectionRelease message in a Cell Reselection process, the UE being in RRC idle mode,
process an RRC Verify-Response message received from the eNB or gNB in response to the RRC Verify-Request message, and
verify authenticity of the eNB or gNB by verifying the RRC Verify-Response message; and
a memory to store the messages for the identity-based authentication and encryption process.

2. The apparatus of claim 1, wherein the RRCConnectionRelease message redirects the UE to a 2G network.

3. The apparatus of claim 1, wherein the RRC Verify-Request message includes:
a UE identity;
a UE nonce;
a Public Verification Token (PVT); and
a signature computed over the UE identity and UE nonce.

4. The apparatus of claim 3, wherein the signature is an Elliptic Curve-Based Certificateless Signatures for Identity-Based Encryption (ECCSI) signature.

5. The apparatus of claim 3, wherein verifying the RRC Verify-Response message includes obtaining the following from the RRC Verify-Response message:
an eNB/gNB nonce;
the UE nonce;
a PVT;
a payload including a Secret Shared Value (SSV); and
a signature computed over the eNB/gNB nonce, UE nonce, and payload.

6. The apparatus of claim 5, wherein the SSV is encrypted using Sakai-Kasahara Key Encryption (SAKKE).

7. The apparatus of claim 5, wherein verifying the RRC Verify-Response message further includes obtaining an eNB/gNB identity from the RRC Verify-Response message.

8. The apparatus of claim 5, wherein the one or more baseband processors are further to:
extract the SSV from the payload upon verifying the RRC Verify-Response message; and
derive an integrity key from the SSV.

9. The apparatus of claim 8, wherein the one or more baseband processors are further to:
utilize the derived integrity key to protect RRC messages until the UE authenticates with the eNB/gNB.

10. The apparatus of claim 9, wherein utilizing the derived integrity key includes generating a Short Message Authentication Code for Integrity (ShortMAC-I) for securing RRC messages.

11. A computer-readable storage medium having stored thereon data representing sequences of instructions that, when executed by a processor, cause the processor to perform operations comprising:
camping a user equipment (UE) on a first cell in a Cell Selection process, the UE being in Radio Resource Control (RRC) idle mode;
performing a Cell Reselection process by the UE in the RRC idle mode;
receiving an RRCConnectionRelease message;
transmitting an RRC Verify-Request message in response to the RRCConnectionRelease message;
receiving an RRC Verify-Response message in response to the RRC Verify-Request message; and
verifying authenticity of an Evolved Node B (eNB) or Next Generation Node B (gNB) by verifying the RRC Verify-Response message.

12. The medium of claim 11, wherein the RRCConnectionRelease message redirects the UE to a 2G network.

13. The medium of claim 11, wherein the RRC Verify-Request message includes:
a UE identity;
a UE nonce;
a Public Verification Token (PVT); and
a signature computed over the UE identity and UE nonce.

14. The medium of claim 13, wherein verifying the RRC Verify-Response message includes obtaining the following from the RRC Verify-Response message:
an eNB/gNB nonce;
the UE nonce;
a PVT;
a payload including a Secret Shared Value (SSV); and
a signature computed over the eNB/gNB nonce, UE nonce, and payload.

15. The medium of claim 14, wherein verifying the RRC Verify-Response message further includes obtaining an eNB/gNB identity from the RRC Verify-Response message.

16. The medium of claim 14, further comprising instructions that, when executed by the processor, cause the processor to perform operations comprising:
upon verifying the RRC Verify-Response message, extracting the SSV from the payload; and
deriving an integrity key from the SSV.

17. The medium of claim 16, further comprising instructions that, when executed by the processor, cause the processor to perform operations comprising:
utilizing the derived integrity key to protect RRC messages until the UE authenticates with the eNB/gNB.

18. A system of a user equipment (UE) to perform an identity-based authentication and encryption process, the system comprising:
one or more baseband processors to:
generate a Radio Resource Control (RRC) Verify-Request message to an Evolved Node B (eNB) or Next Generation Node B (gNB) in response to receiving an RRCConnectionRelease message in a Cell Reselection process, the UE being in RRC idle mode,
process an RRC Verify-Response message received from the eNB or gNB in response to the RRC Verify-Request message, and
verify authenticity of the eNB or gNB by verifying the RRC Verify-Response message;
a memory to store the messages for the identity-based authentication and encryption process;
a transmitter or receiver to transmit or receive signals; and
an antenna for wireless signal reception and transmission.

19. The system of claim 18, wherein the RRCConnectionRelease message redirects the UE to a 2G network.

20. The system of claim 18, wherein the RRC Verify-Request message includes:
a UE identity;
a UE nonce;
a Public Verification Token (PVT); and
a signature computed over the UE identity and UE nonce.

21. The system of claim 20, wherein verifying the RRC Verify-Response message includes obtaining the following from the RRC Verify Response message:
an eNB/gNB nonce;
the UE nonce;
a PVT;
a payload including a Secret Shared Value (SSV); and
a signature computed over the eNB/gNB nonce, UE nonce, and payload.

22. The system of claim 21, wherein verifying the RRC Verify-Response message further includes obtaining an eNB/gNB identity from the RRC Verify-Response message.

23. The system of claim 21, wherein the one or more baseband processors are further to:
extract the SSV from the payload upon verifying the RRC Verify-Response message; and
derive an integrity key from the SSV.

24. The system of claim 23, wherein the one or more baseband processors are further to:
utilize the derived integrity key to protect RRC messages until the UE authenticates with the eNB/gNB.
